(19) United States
(12) Patent Application Publication
(10) Pub. No.: US 2025/0216537 A1
(43) Pub. Date: Jul. 3, 2025

(54) TARGET DETECTION DEVICE, ELECTRONIC DEVICE INCLUDING THE SAME AND OPERATION METHOD

(71) Applicant: Samsung Electronics Co., Ltd., Suwon-si (KR)

(72) Inventors: YOUNGWOOK KIM, SEOUL (KR); JUHO CHA, SEOUL (KR); YUNSOO KIM, SEOUL (KR)

(73) Assignees: Samsung Electronics Co., Ltd., Suwon-si (KR); Sogang University Research & Business Development Foundation, Seoul (KR)

(21) Appl. No.: 18/978,882

(22) Filed: Dec. 12, 2024

(30) Foreign Application Priority Data
Dec. 29, 2023 (KR) 10-2023-0196840
Feb. 26, 2024 (KR) 10-2024-0027575

(51) Int. Cl. G01S 13/28; G06N 3/045; G06N 3/0464; G06N 3/08

(52) U.S. Cl. CPC G01S 13/282; G06N 3/045; G06N 3/0464; G06N 3/08

(57) ABSTRACT

A detection device extracts a plurality of range profiles from a radar signal detected during a time period from a target; determines obtain magnitude variance data defined with respect to a plurality of magnitude components corresponding to a target index in the plurality of range profiles, phase variance data defined with respect to a plurality of phase components corresponding to the target index, scatter plot data defined with respect to a plurality of In-phase Quadrature (IQ) components corresponding to the target index, and spectrogram data defined with respect to the target index and a plurality of adjacent indices adjacent to the target index; and inputs the magnitude variance data, the phase variance data, the scatter plot data, and the spectrogram data into an Artificial Intelligence (AI) model to detect a type of the target.

### CROSS-REFERENCE TO RELATED APPLICATIONS

This patent application claims priority under 35 U.S.C. § 119 to Korean Patent Application Nos. 10-2023-0196840 filed on Dec. 29, 2023, and 10-2024-0027575 filed on Feb. 26, 2024, respectively, in the Korean Intellectual Property Office, the disclosures of which are incorporated by reference in their entireties herein.

### 1. Technical Field

Embodiments of the present disclosure described herein are directed to a target detection device, an electronic device including the target detection device, and a method of operating the same.

### 2. Discussion of Related Art

A Frequency Modulated Continuous Wave (FMCW) radar is a sensor that detects and tracks targets using millimeter waves. Such waves are a specific band of electromagnetic waves with wavelengths ranging from 1 millimeter to 10 millimeters, which corresponds to frequencies between 30 GHz and 300 GHz. In radar technology, millimeter waves (e.g., electromagnetic waves) are utilized due to their short wavelength, which allows for higher resolution and more precise measurements compared to radar systems that use longer wavelengths.

The FMCW radar may transmit electromagnetic waves toward a target and then receive signals reflected by the target to recognize surrounding objects or people and calculate a distance from the target or relative speed through analysis of the received signals. Such FMCW radars are typically used to detect targets at short to medium ranges, and are widely used, for example, in the automotive field. However, it is difficult to apply radar sensors to detect and distinguish a type and a status of a target at an ultra-short range of several centimeters (cm).

### SUMMARY

Embodiments of the present disclosure provide a target detection device capable of detecting a target based on a radar signal for a short-range target, an electronic device including the target detection device, and a method of operating the same.

According to an embodiment of the present disclosure, a detection device includes at least one memory storing at least one instruction, and at least one processor that executes the at least one instruction, and the at least one instruction, when executed, causes the at least one processor to extract a plurality of range profiles from a radar signal detected during a time period from a target, to determine magnitude variance data defined with respect to a plurality of magnitude components corresponding to a target index in the plurality of range profiles, phase variance data defined with respect to a plurality of phase components corresponding to the target index, scatter plot data defined with respect to a plurality of In-phase Quadrature (IQ) components corresponding to the target index, and spectrogram data defined with respect to the target index and a plurality of adjacent indices adjacent to the target index, and input the magnitude variance data, the phase variance data, the scatter plot data, and the spectrogram data into an Artificial Intelligence (AI) model to detect a type of the target.

According to an embodiment of the present disclosure, an electronic device includes a transceiver that transmits and receives a radar signal for a time period with respect to a target, and a controller connected to the transceiver. The controller extracts a plurality of range profiles from the radar signal, obtains magnitude variance data defined with respect to a plurality of magnitude components corresponding to a target index in the plurality of range profiles, phase variance data defined with respect to a plurality of phase components corresponding to the target index, scatter plot data defined with respect to a plurality of In-phase Quadrature (IQ) components corresponding to the target index, and spectrogram data defined with respect to the target index and a plurality of adjacent indices adjacent to the target index, and inputs the magnitude variance data, the phase variance data, the scatter plot data, and the spectrogram data into an Artificial Intelligence (AI) model to detect a type of the target.

According to an embodiment of the present disclosure, a method of operating an electronic device includes extracting a plurality of range profiles from a radar signal detected during a time period from a target, obtaining magnitude variance data defined with respect to a plurality of magnitude components corresponding to a target index in the plurality of range profiles, phase variance data defined with respect to a plurality of phase components corresponding to the target index, scatter plot data defined with respect to a plurality of In-phase Quadrature (IQ) components corresponding to the target index, and spectrogram data defined with respect to the target index and a plurality of adjacent indices adjacent to the target index, and obtaining output data with respect to a plurality of labels defined depending on a type of the target from an Artificial Intelligence (AI) model using the magnitude variance data, the phase variance data, the scatter plot data, and the spectrogram data as input data.

### BRIEF DESCRIPTION OF THE FIGURES

The above and other objects and features of the present disclosure will become apparent by describing in detail embodiments thereof with reference to the accompanying drawings.

FIG. 1 illustrates an electronic device, according to an embodiment.

FIG. 2 illustrates frames and range profiles, according to an embodiment.

FIG. 3 illustrates a block diagram of a controller of the electronic device, according to an embodiment.

FIGS. 4 and 5 illustrate range profiles to describe some operations of the controller.

FIG. 6 illustrates a block diagram of a feature extractor, according to an embodiment.

FIG. 7 illustrates scatter plot data for each label, according to an embodiment.

FIG. 8 illustrates spectrogram data for each label, according to an embodiment.

FIG. 9 illustrates a structure of an AI model, according to an embodiment.

FIG. 10 illustrates a structure of a CNN model, according to an embodiment.

FIG. 11 is a table illustrating classification performance based on an SVM model according to comparative examples.

FIG. 12 is a table illustrating classification performance based on a DCNN model, according to an embodiment.

FIG. 13 is a block diagram illustrating a detection device, according to an embodiment.

FIG. 14 is a flowchart illustrating a method of operating a detection device, according to an embodiment.

FIG. 15 is a flowchart illustrating a method of training an electronic device, according to an embodiment.

FIG. 16 is a flowchart illustrating a method for classifying an electronic device, according to an embodiment.

FIG. 17 illustrates an electronic device, according to an embodiment.

### DETAILED DESCRIPTION

Hereinafter, embodiments of the present disclosure will be described in detail and clearly to such an extent that one of ordinary skill in the art may implement the present disclosure.

FIG. 1 illustrates an electronic device, according to an embodiment.

Referring to FIG. 1, an electronic device 100 according to an embodiment includes a transceiver 110 and a controller 120 (e.g., a controller circuit).

The transceiver 110 may cause the electronic device 100 to communicate with another electronic device 100 or a base station and a network connected to the base station through any wireless network such as a wireless LAN (WLAN), a peer-to-peer (P2P) network, a mesh network, a cellular network, a wireless wide-area-network (WWAN), and/or a wireless personal-area-network (WPAN). The base station may be a fixed point of communication that acts as a central hub for wireless communication.

The transceiver 110 may include a circuit and/or logic for transmitting a transmission signal Tx and receiving a reception signal Rx through an antenna 111. For example, the transceiver 110 may include a transmitter for transmitting the transmission signal Tx and a receiver for receiving the reception signal Rx. For example, the transceiver 110 may be configured to transmit and receive millimeter wave signals through a wireless channel. According to some example embodiments, the millimeter wave signal used to detect a target 102 may be referred to as a radar signal.

According to an example embodiment, the transceiver 110 includes a transmitter that up-converts and amplifies a frequency of a transmitted signal, and a receiver that low-noise amplifies and down-converts a frequency of the received signal. The up-converting may increase the frequency of a signal and the amplifying may increase power or amplitude of the signal. The lower-noise amplifying may be a process of amplifying a signal while adding as little noise as possible and the down-converting may reduce the frequency of the signal. For example, the transmitter may transmit (or radiate) a radar signal through the antenna 111, and the receiver may receive a signal reflected from the target 102 after being radiated through the antenna 111. When generating the radar signal to be radiated, the transmitter may generate the radar signal in the form of a Frequency Modulated Continuous Wave (FMCW). The radar signal to be radiated may include several chirps. The chirp may be expressed as the ratio of a frequency bandwidth to a frequency modulation period. The transmitter may radiate the radar signal in units of burst. In a chirped radar signal, the frequency may start at one value and gradually increases or decreases to another value over a fixed duration in a frequency sweep. A radar signal that is radiated to include several chirps may be transmitted as multiple frequency-modules signals, each with its own frequency sweep (or chirp), in sequence during a single radar operation cycle.

The transceiver 110 may be configured in various ways to transmit and receive wireless signals through the antenna 111, and may be implemented, for example, through various intermediate frequency ICs (IFICs) or various radio frequency ICs (RFICs). The antenna 111 may include, for example, a patch antenna, a patch antenna array, or various types of antennas used in wireless devices.

The controller 120 is communicatively connected to the transceiver 110 and may control the overall operation of the transceiver 110.

According to some example embodiments, the controller 120 may detect the target 102 based on a radar signal received through the transceiver 110.

In detail, the controller 120 may allow the transceiver 110 to transmit and receive the radar signal with respect to the target 102 for a specific time. Under the control of the controller 120, the transceiver 110 may transmit and receive the radar signal every specific frame period for a specific time. Accordingly, the radar signal may be expressed as a plurality of frames included during a specific time.

The controller 120 may extract a plurality of range profiles from the radar signal collected from the target 102 for a specific time. A range profile may be defined with respect to the radar signal obtained at a specific time or in a specific frame. The range profile is information that represents the radar signal and may include magnitude information of the radar signal for each range-bin. For example, an x-axis of the range profile may be defined as a range from the radiation point of the radar signal to the object, and a y-axis may be defined as the magnitude of the radar signal. The range profile may contain data that represents the magnitude (or amplitude) of the reflected radar signals at various specific distance intervals known as range-bins.

The controller 120 may obtain numerical data and image data from the plurality of obtained range profiles. The obtained numerical data and the obtained image data may be used to detect the type of object. The numerical data is data that reflects or represents the degree to which the target 102 trembles, and may be, for example, statistical data of the magnitude or phase of an arbitrary point in the range profile. The numerical data may reflect statistical characteristics of how much the target 102 trembles during the measurement time of the radar signal. The trembles may correspond to small movements of the target 102.

A trembling aspect or an amount of the tremble of the target 102 may be determined from the image data. For example, scatter plot data in which In-phase Quadrature (IQ) components of the range profile are plotted or spectrogram data expressed as time/frequency components of the range profile may be used to determine the amount of the tremble. The image data may reflect changes in components over time and the characteristics of the distribution of components. A scatter plot of the scatter plot data is a type of data visualization that displays the relationship between two variables by plotting individual points on a two-dimensional graph. For example, a type of scatter plot referred to as an IQ plot may be created from the In-phase (I) component of a reflected signal representing the part of the signal that is in phase with a reference signal and the Quadrature (Q) component of the reflected signal representing the part of the signal that is 90 degrees out of phase with the reference signal.

For example, the controller 120 may obtain magnitude variance data defined with respect to a plurality of magnitude components corresponding to a target index indicated by a peak point in the obtained plurality of range profiles, phase variance data defined with respect to a plurality of phase components corresponding to the target index, scatter plot data defined with respect to a plurality of IQ components corresponding to the target index, and spectrogram data defined with respect to the target index and a plurality of adjacent indices adjacent to the target index. The peak point may be a point in a range profile where the magnitude of the reflected signal reaches a local maximum, which may indicate the presence of a strong reflection from a target at a specific distance (range) from the radar. The target index may be a unique identifier associated with a certain target among a plurality of different targets being tracked. The plurality of magnitude components may be measured magnitude values across several range profiles. The phase variance data may indicate the variability or consistency of the phase information of a radar signal reflected from a target. The spectrogram data may provide a time-frequency representation of how the reflected signal changes over time for a target and its neighboring range bins. The obtained magnitude variance data, the obtained phase variance data, the obtained scatter plot data, and the obtained spectrogram data may be applied as input data to an artificial intelligence (AI) model AM.

The controller 120 may input the obtained magnitude variance data, the obtained phase variance data, the obtained scatter plot data, and the obtained spectrogram data into the AI model AM, and may obtain output data for a plurality of labels defined according to a type of the target 102 from the AI model AM. The plurality of labels may be defined according to the type of the target 102 (e.g., whether the target 102 is an object or a person, a type of the object, whether the target 102 is dynamic or static, etc.). The plurality of labels may include at least one label associated with an object and one or more labels associated with a person. The output data for a plurality of labels may be defined as a probability value that the target 102 belongs to each of the plurality of labels. For example, if the AI model AM is trained to detect an insect and a person, and the output data indicates 70% for the target 102 being a person and 30% for the target 102 being an insect, the system could take evasive action since it is likely that the target 102 is a person.

The AI model AM may be trained and configured to output the probability value that the target 102 corresponding to the input data belongs to each of the plurality of labels from the above-described input data. According to some example embodiments, the controller 120 may train the AI model AM based on training data (e.g., examples), or may output a probability value from the AI model AM which is trained in advance.

In an embodiment, the AI model AM receives both numerical data and image data as input data, and has a structure that combines (or fuses) the numerical data and the image data. When only numerical data is used as the input data, only the degree of tremble of the target 102 during the measurement time may be reflected. Accordingly, classification between the non-tremble target 102 and the tremble target 102 may be performed with high accuracy, but classification performance for targets 102 with similar tremble will be poor. However, since numerical data reflects only the degree of tremble, it is difficult to reflect information about changes in features over time or the variance pattern of tremble.

In addition to numerical data, image data representing the variance pattern of tremble is used as input data for the AI model AM, so the present disclosure may not only provide classification between people and objects, but may also provide more detailed classification, such as types of objects or types of motion (e.g., different people motions).

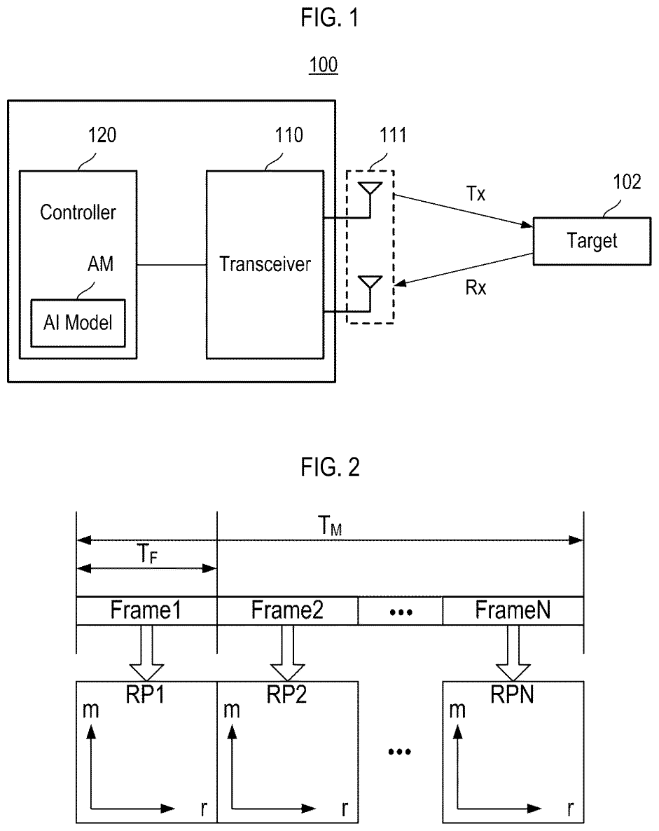

FIG. 2 illustrates frames and range profiles, according to an embodiment.

Referring to FIG. 2, the transceiver 110 of FIG. 1 may transmit and receive a radar signal with respect to a target every specific frame period T_{F} for a specific time T_{M}. Therefore, the transmitted and received radar signal may include a plurality of frames within a specific time as illustrated, and the number ‘N’ of the plurality of frames, is a natural number and may be defined as a value obtained by dividing the specific time T_{M} by the specific frame period T_{F}. The specific time T_{M} and the specific frame period T_{F} may have preset values or may be set dynamically by the controller 120. In an embodiment, the specific time T_{M} is set according to the type of the electronic device 100 of FIG. 1. For example, when the electronic device 100 requires control of transmission output power in real time, such as a mobile device, the specific time T_{M} may be set shorter.

According to some embodiments, the specific time T_{M} may be divided or cropped from the entire measurement time. In this case, a plurality of frames included in the specific time T_{M} may form one unit of data. The unit data may be defined as one piece of data input to the AI model AM of FIG. 1.

One range profile may be defined in one frame. In detail, a plurality of range profiles RP1 to RPN may be defined for one unit of data. Each of the plurality of range profiles RP1 to RPN is defined for each of the plurality of frames included in the specific time T_{M}, and may be defined as the magnitude of the radar signal according to the range or distance to the target. Like the frames, ‘N’ multiple range profiles RP1 to RPN may be defined. For example, the first range profile RP1 may be determined from the reflected signal that is detected during the first frame period, the second range profile RP2 may be determined from the reflected signal that is detected during the second frame period, etc.

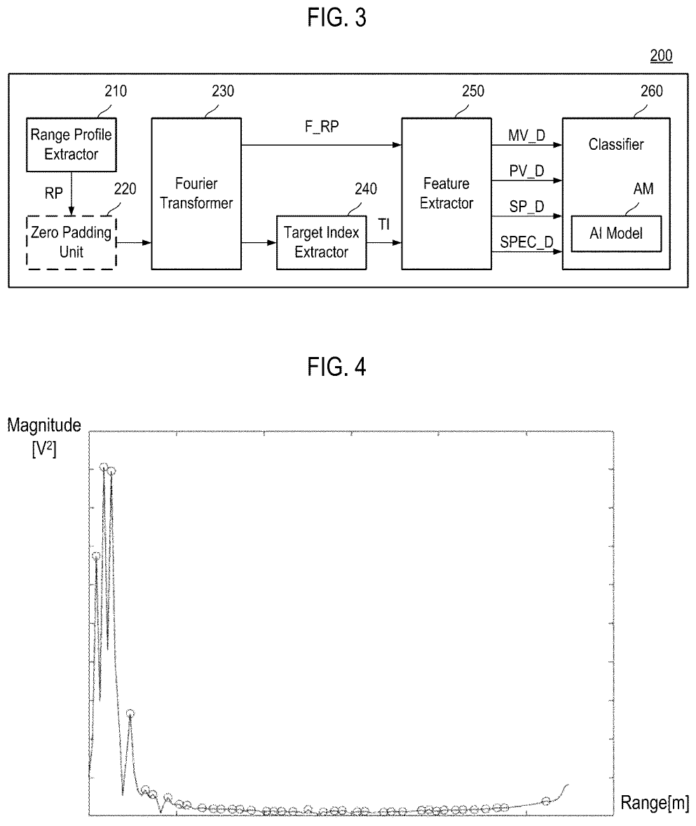

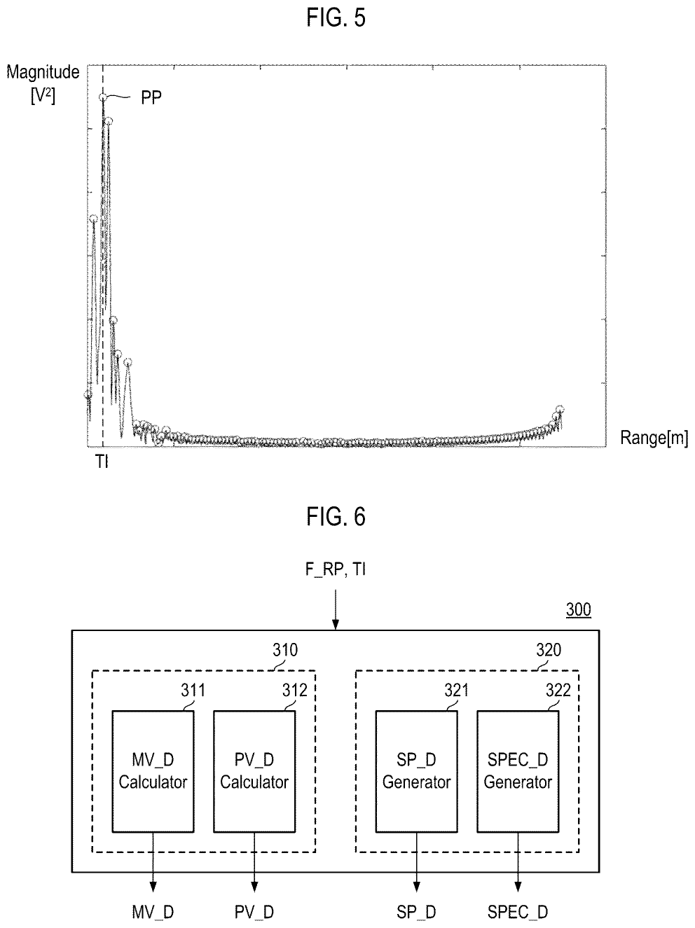

FIG. 3 illustrates a block diagram of the controller 200, according to an embodiment, and FIGS. 4 and 5 illustrate range profiles to describe some operations of the controller 200.

Referring to FIG. 3, the controller 200 according to an embodiment includes a range profile extractor 210, a zero padding unit 220, a Fourier transformer 230, a target index extractor 240, a feature extractor 250, and a classifier 260. The components of the controller 200 may each be implemented by a corresponding logic circuit or each of the components may be implemented by a computer program that is stored on a memory of the controller 200 that are executed by a processor of the controller 200.

The range profile extractor 210 may extract a plurality of range profiles RP from radar signals collected from the target for a specific time. For example, the range profile extractor 210 may receive radar signals from various angles from the target and may generate a graph illustrating a magnitude of the reflection intensity according to the range of the target 102 as the range profile RP based on the received radar signals. The range profile RP represents the intensity of the reflected radar signal depending on the range, so it may be used to determine the shape or features of the target. The various angles may be with respect a location of the electronic device 100 and a location of the target 102, a location of the transceiver 110 and the location of the target 102 or a location of the antenna 111 and a location of the target 102.

The range profile extractor 210 may generate the range profile RP for each frame included at a specific time.

The zero padding unit 220 may preprocess original data by applying zero padding to the generated plurality of range profiles RP. For example, the zero padding unit 220 may determine the number of zero data (i.e., ‘0’) to be added to the range profile RP, which is the original data, and may insert the determined number of zero data into the original data. Each range profile RP to which the zero padding is applied may have a new length. The zero padding unit 220 may insert zero data at various positions in each range profile RP.

The plurality of range profiles to which the zero padding is applied may have a higher range resolution than the original data. In detail, the plurality of range profiles with zero padding applied may represent higher resolution than the original data when converted to discrete data. When the zero padding is applied, closer targets may be detected more easily as the range resolution of the range profile RP becomes higher.

The Fourier transformer 230 may perform a Fourier transform on the plurality of range profiles to which the zero padding is applied. Through the Fourier transform, the range profile RP may be converted to a frequency domain. For example, the Fourier transformer 230 may perform Fourier transforms such as a Discrete Fourier Transform (DFT), a Fast Fourier Transform (FFT), and a Short-Time Fourier Transform (STFT). In an embodiment, the zero padding unit 220 is omitted and the Fourier transformer 230 performs a Fourier transform on a range profile that has not been zero padded. For example, the Fourier transformer 230 may output Fourier transformed range profiles F_RP.

The target index extractor 240 may extract the index of a peak point from a plurality of Fourier transformed range profiles F_RP as a target index TI. Hereinafter, the operations of the zero padding unit 220, the Fourier transformer 230, and the target index extractor 240 will be described with reference to FIGS. 4 and 5.

The range profile RP, which is the original data initially obtained through the range profile extractor 210, is illustrated in FIG. 4. As illustrated, an x-axis is defined as the range to the target (e.g., in meters), and a y-axis is defined as the magnitude of the received radar signal. For example, the magnitude may be based on a root mean square voltage of the received radar signal being squared. When converted to discrete data through Fourier transform, the range profile RP may be sampled at uniform intervals like a circular point. Since the resolution in FIG. 4 is low on the x-axis, the zero padding may be applied through the zero padding unit 220 for short-range detection.

The range profile RP with zero padding applied is as illustrated in FIG. 5, and it may be seen that the range resolution is increased as the sampling interval is reduced compared to FIG. 4. When the target index TI with respect to the preprocessed range profile is extracted, the target index extractor 240 may extract the data with the highest magnitude among the sampled data, that is, the index of a peak point PP as the target index TI.

Returning to FIG. 3, the feature extractor 250 may extract features that are input data of the AI model AM based on the plurality of Fourier transformed range profiles F_RP and the target index TI. According to an example embodiment, the features include magnitude variance data MV_D, phase variance data PV_D, scatter plot data SP_D, and spectrogram data SPEC_D as described above. Accordingly, the feature extractor 250 may extract not only numerical data indicating the degree to which the target trembles over time, but also image data indicating the manner in which the target trembles over time.

The classifier 260 may input the magnitude variance data MV_D, the phase variance data PV_D, the scatter plot data SP_D, and the spectrogram data SPEC_D extracted from the feature extractor 250 into the AI model AM, and may output the output data corresponding to the classification result of the target from the AI model AM.

According to the above-described embodiments, the controller 200 of the present disclosure may increase classification performance for closer targets by increasing range resolution through preprocessing of the range profile RP. Additionally, the present disclosure may increase classification accuracy for targets by using the numerical data and the image data as input data for the AI model AM.

FIG. 6 illustrates a block diagram of a feature extractor, according to an embodiment. The feature extractor may be used to implement the feature extractor 250 of FIG. 3.

Referring to FIG. 6, a feature extractor 300 according to an embodiment includes a numerical data calculator 310 including a magnitude variance data (MV_D) calculator 311 and a phase variance data (PV_D) calculator 312, and an image data generator 320 including a scatter plot data (SP_D) generator 321 and a spectrogram data (SPEC_D) generator 322. In common, the magnitude variance data calculator 311, the phase variance data calculator 312, the scatter plot data generator 321, and the spectrogram data generator 322 may perform operations using the plurality of Fourier transformed range profiles F_RP and the target index TI.

According to an embodiment, the magnitude variance data calculator 311 obtains a plurality of magnitude components from a plurality of frames included at a specific time. In this case, each magnitude component may be a magnitude component corresponding to the target index TI of the range profile corresponding to each frame. A signal corresponding to the target index TI may have, a complex number form of Re+j*Im, where Re is a real component and Im is an imaginary component, and the magnitude variance data calculator 311 may calculate a magnitude component through \sqrt{Re²+Im²}.

The magnitude variance data calculator 311 may obtain the magnitude variance data MV_D based on an average of the obtained plurality of magnitude components. In detail, the magnitude variance data calculator 311 may calculate the magnitude variance for one unit of data. For example, the magnitude variance data calculator 311 may calculate the magnitude variance data MV_D by dividing a Relative Standard Deviation (RSD) E[(X−μ)²] by ‘μ’. Here, ‘X’ is defined as the magnitude component for the target index TI of one frame, ‘μ’ is defined as the average value for the magnitude component and E[ ] is defined as an expected value. The magnitude component varies in scale depending on the type of target, but when the RSD is used, there is an advantage in narrowing this difference in scale.

The phase variance data calculator 312 may obtain a plurality of phase components from a plurality of frames included in a specific time. In this case, each phase component may be a phase component corresponding to the target index TI of the range profile corresponding to each frame. For example, for a signal in the form of a complex number corresponding to the target index TI, the phase variance data calculator 312 may calculate the phase component through tan⁻¹[Im/Re].

The phase variance data calculator 312 may obtain the phase variance data PV_D based on the average of a plurality of obtained phase components. For example, the phase variance data calculator 312 may calculate the phase variance data PV_D from E[(X−μ)²], which is the standard deviation. Here, ‘X’ is defined as the phase component for the target index TI of one frame, ‘μ’ is defined as the average value for the phase component, and E[ ] is defined as an expected value. When the phase component, unlike the magnitude component, is normalized to a range of ‘0’ to 2 pi, the standard deviation may be used.

The scatter plot data generator 321 may obtain a plurality of IQ components from a plurality of frames included in a specific time and may obtain the scatter plot data SP_D based on accumulating the plurality of IQ components in one complex plane. Each IQ component may be an IQ component of the target index TI of the range profile corresponding to each frame. The scatter plot data generator 321 may accumulate and plot the plurality of IQ components for the target index TI of each of the plurality of frames in a complex plane, and may obtain the corresponding complex plane as the scatter plot data SP_D.

The spectrogram data generator 322 may obtain the spectrogram data SPEC_D by accumulating the plurality of Fourier transformed range profiles F_RP with respect to the target index TI and a plurality of adjacent indices. In an embodiment, the Fourier transform is a Short-Term Fourier Transform (STFT) to be performed on adjacent indices around the target index TI. The range profile converted to the frequency domain according to the Fourier transform may be accumulated on a plane with an x-axis as time and a y-axis as frequency. The corresponding plane, that is, the spectrogram data SPEC_D, may visually express the frequency component at each time. For example, the spectrogram data SPEC_D may be expressed as a heat map, and the brightness or the hue of a color may indicate the intensity of the corresponding frequency component.

According to some embodiments, the number (or the range of the window that is the target of the STFT) of indices to be accumulated to generate the spectrogram data SPEC_D may be set in advance or dynamically set by a controller.

The spectrogram data SPEC_D may indicate how the target's tremble changes over time. The above-mentioned numerical data may not include information about how the target trembles at a specific time, but the spectrogram data SPEC_D may indicate how much the target trembles at any time point during the measurement period.

According to the above-described embodiments, the present disclosure may extract features from various perspectives (target's trembling degree, or target's trembling pattern) of the target's radar signal through the feature extractor 300. As more diverse features are extracted, the classification performance of the target to be performed using the corresponding features may be increased.

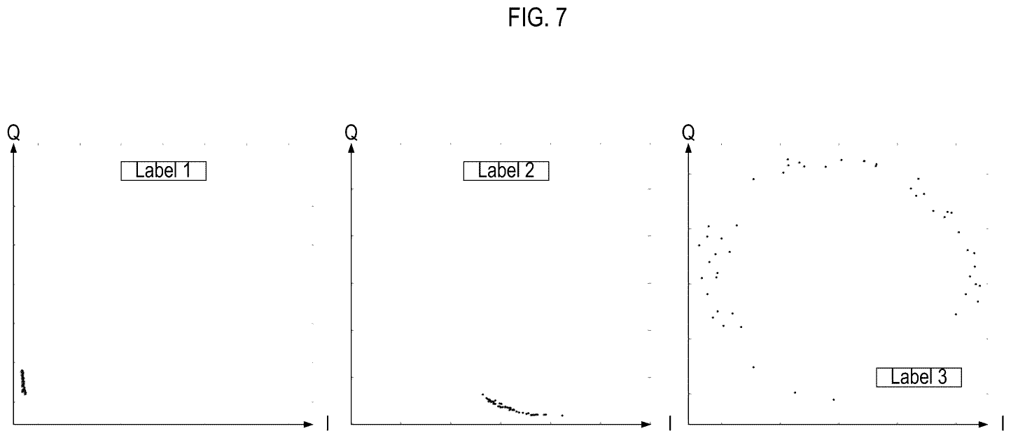

FIG. 7 illustrates scatter plot data for each label, according to some embodiments.

Referring to FIG. 7, for example, it is assumed that scatter plot data is generated for the first to third labels. The type and number of labels may be set in various ways, but here it is assumed that the first label is defined for a dynamic object, the second label is defined for a static person, and the third label is defined for a dynamic person (e.g., a moving person). The scatter plot data may be a two-dimensional graph of accumulated IQ components. Accumulation means that a sequence of multiple range profiles corresponding to one unit of data are displayed together on a complex plane.

In the case of the first label corresponding to a dynamic object, the scatter plot data represents a relatively dynamic variance of the Q component. In the case of the second label corresponding to a static person, the scatter plot data represents a relatively dynamic variance of the I component. In the case of the third label corresponding to a dynamic person, the scatter plot data represents the various variances of IQ components.

As illustrated, the scatter plot data may represent various aspects depending on a type of label and a pattern of label. Such scatter plot data may contribute to a training operation for classifying targets from a different perspective than numerical data representing numerical values.

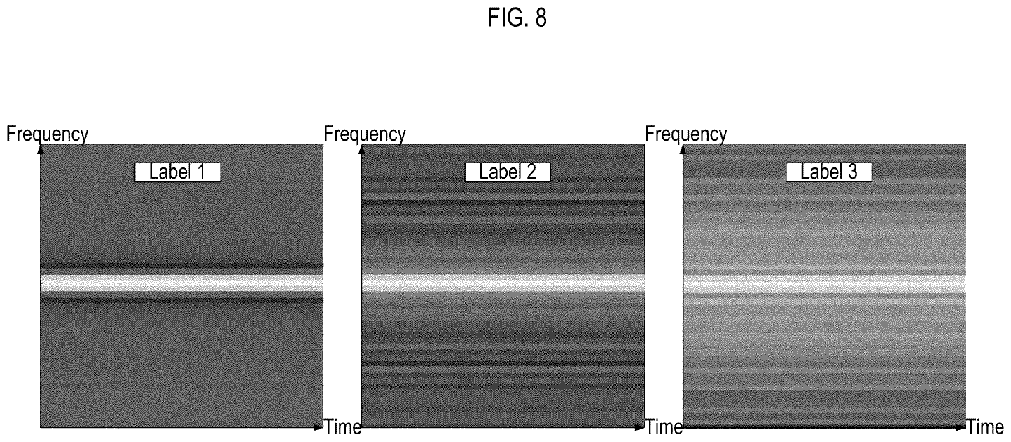

FIG. 8 illustrates spectrogram data for each label, according to some embodiments.

Referring to FIG. 8, for example, it is assumed that the spectrogram data is generated for the first to third labels. In FIG. 8, it is assumed that the first label is defined for a static object, the second label is defined for a static person, and the third label is defined for a dynamic person. The spectrogram data is defined on a plane with time as an x-axis and frequency as a y-axis. The lighter the shading color of the spectrogram data, the higher the value may be expressed.

In particular, unlike other features, the spectrogram data may indicate changes in frequency over time. The frequency axis, which is the y-axis, may represent a velocity component of the target. For example, when the variance of the target's velocity components during the measurement time is narrow (e.g., the first label and the second label), the spectrogram data with data tending to be concentrated in one area is generated. Alternatively, when the variance of the velocity component of the target is wide (e.g., the third label), the spectrogram data with data tending to be spread over several areas is generated.

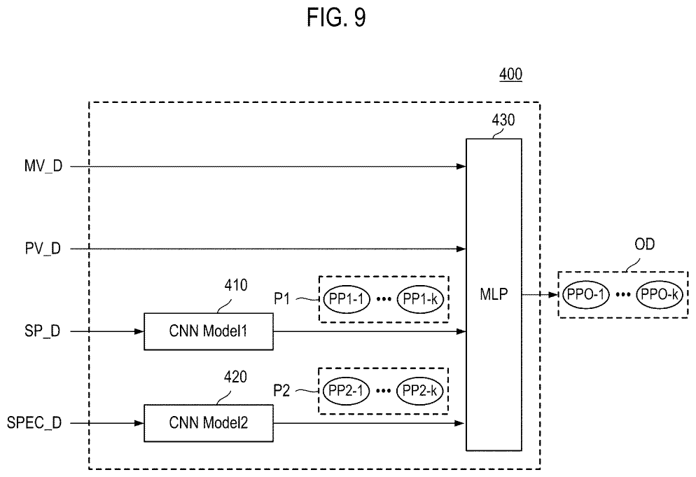

FIG. 9 illustrates a structure of an AI model, according to some embodiments.

Referring to FIG. 9, the AI model AM according to an embodiment is composed of a Deep Convolution Neural Network (DCNN) model. For example, the AI model AM may include a first convolution neural network (CNN) model 410, a second CNN model 420, and a multi-layer perceptron (MLP) 430. The input data of the AI model AM may be the magnitude variance data MV_D, the phase variance data PV_D, the scatter plot data SP_D, and the spectrogram data SPEC_D, as above-described.

The first CNN model 410 may be configured to obtain first prediction data P1 for a plurality of labels from the scatter plot data SP_D. The first CNN model 410 may have a structure in which a plurality of convolutional layers, a plurality of pooling layers, and an MLP (or Fully-Connected layer) are connected, and may be configured to extract a feature map from the input data (i.e., the scatter plot data SP_D) and to output the first prediction data P1 from the input data based on the feature map. In this case, the first prediction data PI may include several probability values PP1-1 to PP1-k in which the targets corresponding to the scatter plot data SP_D belongs to each of a plurality of labels.

The second CNN model 420 may be configured to obtain second prediction data P2 for a plurality of labels from the spectrogram data SPEC_D. The second CNN model 420 may also have the same structure as the first CNN model 410, may be configured to extract a feature map from the input data (i.e., the spectrogram data SPEC_D), and to output the second prediction data P2 from the input data based on the feature map. In this case, the second prediction data P2 may include several probability values PP2-1 to PP2-k in which the targets corresponding to the spectrogram data SPEC_D belongs to each of a plurality of labels.

The MLP 430 may be configured to output output data OD from the magnitude variance data MV_D, the phase variance data PV_D, the first prediction data P1, and the second prediction data P2. An output terminal of the first CNN model 410 and an output terminal of the second CNN model 420 are connected to an input terminal of the MLP 430. The MLP 430 receives the first prediction data P1 and the second prediction data P2, as inputs. In addition, the numerical data (e.g., PV_D) is input directly into the MLP 430. Ultimately, the MLP 430 receives input data that is a mixture of the numerical data and the image data. The MLP 430 may have an input layer, one or more hidden layers, and an output layer, and may output several probability values PPO-1 to PPO-k in which the targets for the input data belongs to each of a plurality of labels, according to a weight, a bias, an activation function, etc. associated with each layer, as the output data OD.

The AI model AM according to the above-described embodiments uses the image data as the input data in addition to the numerical data. When only the numerical data is used, for example, models that perform classification tasks based on the numerical data, such as a Support Vector Machine (SVM), may also be used. However, since the SVM is not suitable for using the image data as the input, the AI model AM of the present disclosure, which uses both the numerical data and the image data, may be implemented with the DCNN model according to the above-described embodiments. Since the AI model AM performs classification of the target by considering both the numerical data and the image data, it may provide more accurate classification performance by considering both the degree and the aspect of the target's tremble.

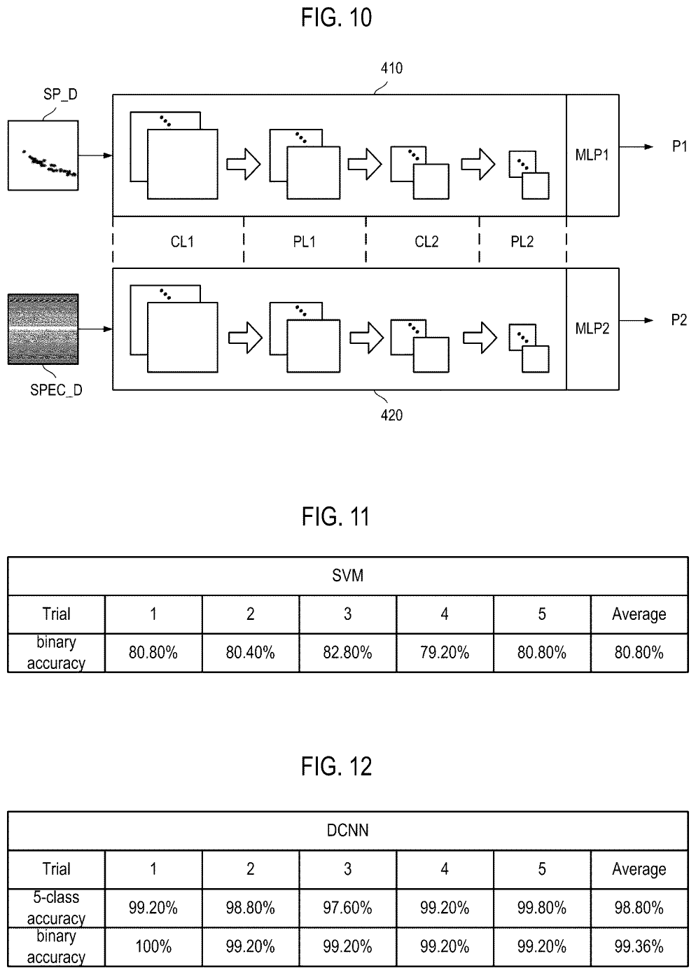

FIG. 10 illustrates a structure of a CNN model, according to an embodiment.

Referring to FIG. 10, the first CNN model 410 takes the scatter plot data SP_D as an input, and the second CNN model 420 takes the spectrogram data SPEC_D as an input. In common, the first CNN model 410 and the second CNN model 420 may include a plurality of convolution layers CL1 and CL2, a plurality of pooling layers PL1 and PL2, and MLP (MLP1 or MLP2), respectively. Each convolution layer extracts a feature map based on a filter (or a kernel) from the input data. The number and magnitude of the filter, the magnitude of stride, which is the filtering interval of the filter, etc. may be set in various ways depending on the type and number of labels.

Each pooling layer may reduce the dimension of the feature map output from the convolution layer or may delete areas with low correlation between feature maps. For example, the pooling layer may reduce the feature map based on max pooling or average pooling. The MLP is configured at the last stage of each CNN model and may output the first prediction data P1 and the second prediction data P2 from the feature map.

FIG. 11 is a table illustrating classification performance based on an SVM model according to comparative examples, and FIG. 12 is a table illustrating classification performance based on a DCNN model, according to some embodiments.

FIG. 11 illustrates classification simulation results for the SVM model for comparison, and represents a case where only the magnitude variance data and the phase variance data are used as input data. A Gaussian function is used as the kernel function of the SVM model, and a kernel scale of 0.35 is set. FIG. 12 illustrates classification simulation results for the DCNN model configured according to the above-described embodiments, and represents a case where the magnitude variance data, the phase variance data, the scatter plot data, and the spectrogram data are used as input data. A classification case (5-class) for five labels and a classification case (binary) for two labels are illustrated together. In the 5-class case, simulations are performed for three object labels (‘table static’, ‘chair static’, and ‘car static’) and two person labels (‘hand static’ and ‘hand dynamic’).

It may be seen that the overall classification performance is relatively higher in cases where the DCNN model is used according to the embodiments of the present disclosure. In particular, in the case of the SVM model, classification is possible for only two labels, whereas the present disclosure may classify more diverse types and types of labels.

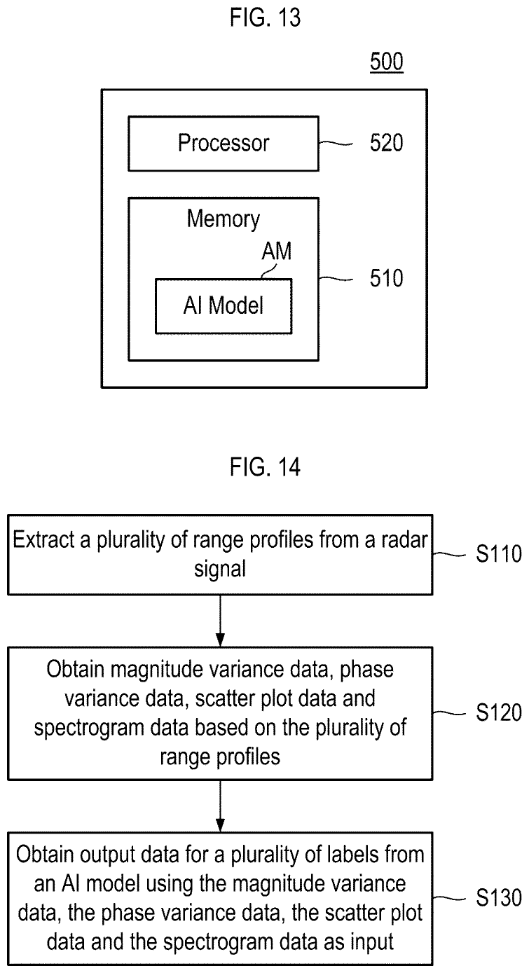

FIG. 13 is a block diagram illustrating a detection device, according to an embodiment.

Referring to FIG. 13, a detection device 500 according to an embodiment may include a memory 510 and a processor 520.

One or more memories 510 may be provided and connected to the processor 520, and may store various information related to the operation of the processor 520. For example, the memory 510 may perform some or all of the processes controlled by the processor 520, or may store software code including at least one instruction for performing descriptions, functions, procedures, proposals, methods, and/or operational flowcharts of the present disclosure. The memory 510 may store the AI model AM, the magnitude variance data to be input to the AI model AM, the phase variance data, the scatter plot data, the spectrogram data, the training data for training, the verification data, the test data, etc. according to the above-described embodiments.

The one or more processors 520 are provided to control the memory 510 and may be configured to implement descriptions, functions, procedures, proposals, methods, and/or operation flowcharts of the present disclosure by executing at least one instruction stored in the memory 510. Additionally, the processor 520 may provide operations according to various embodiments of the present disclosure based on instructions stored in the memory 510. In addition, the processor 520 may process information stored in the memory 510 to generate data. For example, the processor 520 may be configured to implement the functions and operations of the controller according to the above-described embodiments.

According to some embodiments, the processor 520 may extract a plurality of range profiles from radar signals (e.g., radar signals obtained from the transceiver 110 of FIG. 1) collected from the target for a specific time. The processor 520 may obtain the magnitude variance data, the phase variance data, the scatter plot data, and the spectrogram data from the plurality of range profiles. The processor 520 may input the magnitude variance data, the phase variance data, the scatter plot data, and the spectrogram data, which are obtained into the AI model AM stored in the memory 510, and may obtain output data for multiple labels defined according to the type of the target from the AI model AM.

According to some embodiments, the processor 520 may train the AI model AM based on inputting training data including the magnitude variance data, the phase variance data, the scatter plot data, and the spectrogram data into the AI model AM. Alternatively, according to some embodiments, the AI model AM may be trained in advance.

According to the above-described embodiments, the detection device 500 of the present disclosure uses the image data representing the variance pattern of tremble in addition to the numerical data as input data for an AI model AM, so that it is possible to achieve not only classification between a person and an object, but also more detailed classification performance, such as the type of the object or the type of a person's motion.

FIG. 14 is a flowchart illustrating a method of operating a detection device, according to some embodiments.

Referring to FIG. 14, in operation S110, the detection device extracts a plurality of range profiles from a radar signal collected from the target for a specific time. Each range profile may be extracted from each frame.

In operation S120, the detection device may obtain numerical data and image data that will be input data of the AI model from signals of the target index in the plurality of range profiles. For example, the detection device may obtain magnitude variance data, phase variance data, scatter plot data and spectrogram data based on the plurality of range profiles.

In operation S130, the detection device may output the output data including a probability value that the target belongs to each of a plurality of labels, based on inputting the obtained numerical data and the image data into the AI model. For example, the detection device may obtain output data for a plurality of labels from the AI model using the magnitude variance data, the phase variance data, the scatter plot data and the spectrogram data, for input to the AI model.

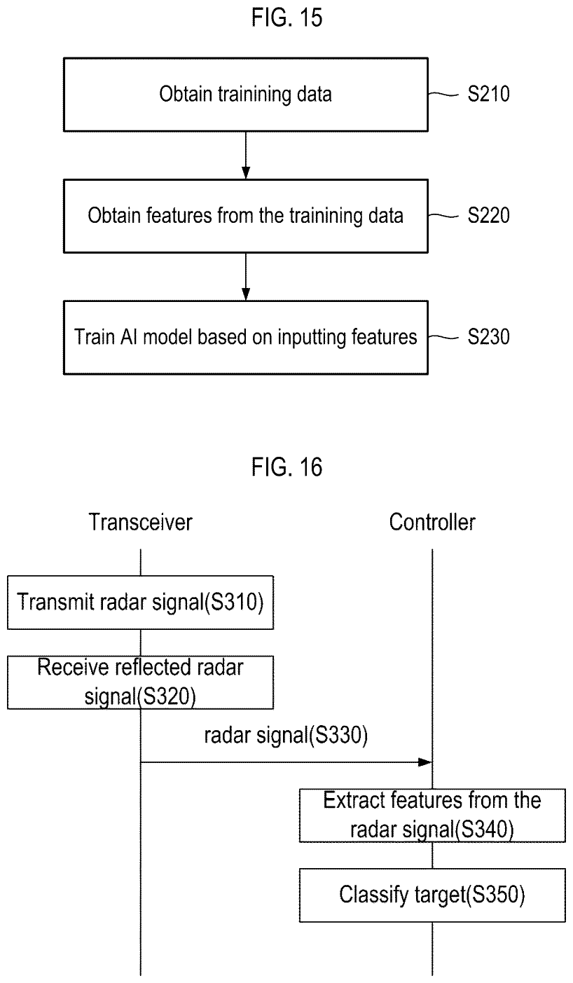

FIG. 15 is a flowchart illustrating a method of training an electronic device, according to an embodiment.

Referring to FIG. 15, in operation S210, the electronic device obtains training data. For example, the training data may include a plurality of unit data. Each unit data may be a radar signal corresponding to a plurality of frames collected during a specific time according to the above-described embodiments. The electronic device may use some of the multiple unit data collected over a measurement time (larger than the specific time) as the training data.

In operation S220, the electronic device obtains features from the training data. For example, the features may include the numerical data and the image data described above.

In operation S230, the electronic device trains the AI model by inputting the obtained features into the AI model. The training may proceed in the direction of minimizing a loss function.

In addition, the training method may further include performing verification on the trained AI model based on verification data and test data.

FIG. 16 is a flowchart illustrating a method for classifying an electronic device, according to an embodiment.

Referring to FIG. 16, in operation S310, the transceiver (e.g., transceiver 110 of FIG. 1) transmits a radar signal to the target. In operation S320, the transceiver receives a radar signal reflected from the target. Operations S310 and S320 may be performed every specific frame period for a specific time. In operation S330, the transceiver transfers the received radar signal to the controller.

In operation S340, the controller extracts features from the received radar signal. According to some embodiments, the controller may further perform an operation of extracting a range profile from the radar signal to extract features, preprocessing the extracted range profile, Fourier transforming the preprocessed range profile, or detecting a target index from the Fourier transformed range profile. For example, an operation of preprocessing the range profile may be applying a zero padding to the range profile. In operation S350, the controller classifies the target based on the extracted features and the AI model.

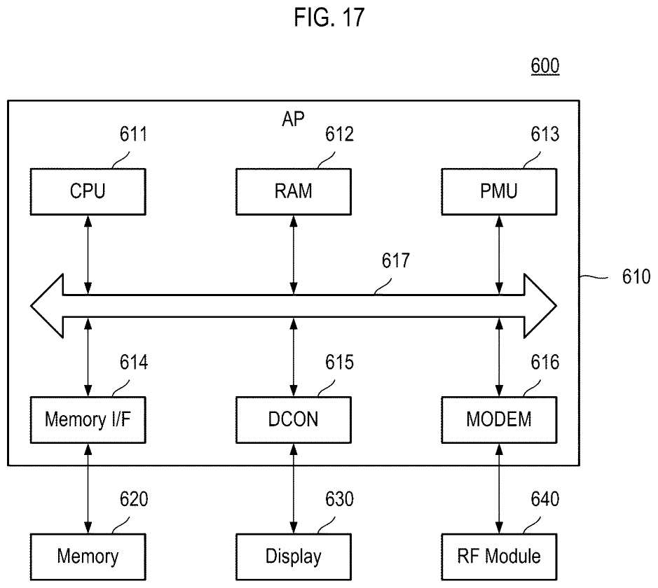

FIG. 17 illustrates an electronic device, according to an embodiment.

Referring to FIG. 17, an electronic device 600 may be, for example, a mobile terminal and may include an application processor (AP) 610, a memory 620, a display 630, and a radio frequency (RF) module 640. In addition, the electronic device 600 may further include various components such as a lens, a sensor, and an audio module.

The AP 610 may be implemented with a system on chip (SoC) and may include a central processing unit (CPU) 611, a random-access-memory (RAM) 612, a power management unit (PMU) 613, a memory interface (I/F) 614, a display controller (DCON) 615, a MODEM 616, and a system bus 617. In addition, the AP 610 may further include various intellectual properties. The AP 610 may be integrated with a function of a MODEM chip therein, which may be referred to as a “ModAP”.

The CPU 611 may generally control operations of the AP 610 and the electronic device 600. The CPU 611 is configured to execute at least one instruction stored in the RAM 612, and may control the operation of each component of the AP 610 using the instruction. Also, the CPU 611 may be implemented with a multi-core. The multi-core may be one computing component having two or more independent cores.

The RAM 612 may temporarily store programs, data, or at least one instruction. For example, the programs and/or data stored in the memory 620 may be temporarily stored in the RAM 612 under control of the CPU 611 or depending on a booting code. The RAM 612 may be implemented with a dynamic-random-access-memory (DRAM) or a static-random-access-memory (SRAM).

The PMU 613 may manage power of each component of the AP 610. The PMU 613 may also determine an operating situation of each component of the AP 610 and may control an operation thereof.

The memory interface 614 may control overall operations of the memory 620 and may control data exchange of the memory 620 with each component of the AP 610. Depending on a request of the CPU 611, the memory interface 614 may write data in the memory 620 or may read data from the memory 620. For example, the memory 620 may store various information (e.g., the AI model AM, input data of the AI model AM, etc.) according to the above-described embodiments.

The display controller 615 may provide the display 630 with image data to be displayed on the display 630. The display 630 may be implemented with a flat panel display, such as a liquid crystal display (LCD) or an organic light emitting diode (OLED) display, or a flexible display.

For wireless communication, the MODEM 616 may modulate data to be transmitted so as to be appropriate for a wireless environment and may recover received data. The MODEM 616 may perform digital communication with the RF module 640.

The RF module 640 may convert a high-frequency signal received through an antenna into a low-frequency signal and may transmit the converted low-frequency signal to the MODEM 616. In addition, the RF module 640 may convert a low-frequency signal received from the MODEM 616 into a high-frequency signal and may transmit the converted high-frequency signal to the outside of the electronic device 600 through the antenna. Also, the RF module 640 may amplify or filter a signal.

For reference, the transceiver 110 and the antenna 111 described above with reference to FIG. 1 may be implemented in the RF module 640.

According to some embodiments, the CPU 611 may perform functions and operations of the components according to the above-described embodiments (e.g., FIGS. 1 to 17) based on executing at least one instruction stored in the RAM 612. For example, the CPU 611 may obtain the radar signal for a target from the RF module 640 and may extract the range profile from the radar signal. The CPU 611 may extract features to be input to the AI model stored in the memory 620 from the range profile and may input the features to the AI model to obtain classification results for the target.

According to an embodiment of the present disclosure, a target detection device capable of detecting a target based on a radar signal for a short-range target, an electronic device including the target detection device, and a method of operating the same may be provided.

The above descriptions refers to specific embodiments for carrying out the present disclosure. Embodiments in which a design of these embodiments is changed slightly may be included in the present disclosure as well. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A detection device comprising:
at least one memory storing at least one instruction; and
at least one processor configured to execute the at least one instruction, and
wherein the at least one instruction, when executed, causes the at least one processor to:
extract a plurality of range profiles from a radar signal detected from a target during a time period;
determine magnitude variance data defined with respect to a plurality of magnitude components corresponding to a target index in the plurality of range profiles, phase variance data defined with respect to a plurality of phase components corresponding to the target index, scatter plot data defined with respect to a plurality of In-phase Quadrature (IQ) components corresponding to the target index, and spectrogram data with respect to the target index and a plurality of adjacent indices adjacent to the target index; and
input the magnitude variance data, the phase variance data, the scatter plot data, and the spectrogram data into an Artificial Intelligence (AI) model to detect a type of the target.

2. The detection device of claim 1, wherein each of the plurality of range profiles is defined with respect to each of a plurality of frames included in the time period, and is defined as a magnitude of the radar signal depending on a range from the target.

3. The detection device of claim 1, wherein the at least one instruction, when executed, causes the at least one processor to:
apply zero padding to the plurality of range profiles;
perform a Fourier transform on the plurality of range profiles to which the zero padding is applied to generate Fourier transformed range profiles; and
extract an index of a peak point from the plurality of Fourier transformed range profiles as the target index.

4. The detection device of claim 1, wherein the at least one instruction, when executed, causes the at least one processor to:
obtain the plurality of magnitude components from a plurality of frames included in the time period; and
obtain the magnitude variance data based on an average of the plurality of magnitude components.

5. The detection device of claim 1, wherein the at least one instruction, when executed, causes the at least one processor to:
obtain the plurality of phase components from a plurality of frames included in the time period; and
obtain the phase variance data based on an average of the plurality of phase components.

6. The detection device of claim 1, wherein the at least one instruction, when executed, causes the at least one processor to:
obtain the plurality of IQ components from a plurality of frames included in the time period; and
obtain the scatter plot data based on accumulating the plurality of IQ components into one complex plane.

7. The detection device of claim 1, wherein the at least one instruction, when executed, causes the at least one processor to:
perform a Short-Time Fourier Transform (STFT) on the plurality of range profiles with respect to the target index and the plurality of adjacent indices; and
obtain the spectrogram data by accumulating the plurality of STFT range profiles.

8. The detection device of claim 1, wherein the AI model is a Deep Convolution Neural Network (DCNN) model.

9. The detection device of claim 1, wherein the AI model comprises:
a first convolution neural network (CNN) model configured to obtain first prediction data with respect to a plurality of labels from the scatter plot data that are defined depending on the type of the target;
a second CNN model configured to obtain second prediction data with respect to the plurality of labels from the spectrogram data; and
a multi-layer perceptron (MLP) configured to generate output data from the magnitude variance data, the phase variance data, the first prediction data, and the second prediction data.

10. The detection device of claim 9, wherein an output terminal of the first CNN model and an output terminal of the second CNN model are connected to an input terminal of the MLP.

11. The detection device of claim 9, wherein the output data, the first prediction data, and the second prediction data are probability values that the target belongs to a corresponding one of the plurality of labels.

12. The detection device of claim 1, wherein the at least one instruction, when executed, causes the at least one processor to:
input training data into the AI model to train the AI model, the training data including examples of the magnitude variance data, the phase variance data, the scatter plot data, and the spectrogram data that are associated with corresponding labels of the AI model that depend on the type of the target.

13. An electronic device comprising:
a transceiver configured to transmit and receive a radar signal for a time period with respect to a target; and
a controller connected to the transceiver, and
wherein the controller is configured to:
extract a plurality of range profiles from the radar signal;
determine magnitude variance data defined with respect to a plurality of magnitude components corresponding to a target index in the plurality of range profiles, phase variance data defined with respect to a plurality of phase components corresponding to the target index, scatter plot data defined with respect to a plurality of In-phase Quadrature (IQ) components corresponding to the target index, and spectrogram data defined with respect to the target index and a plurality of adjacent indices adjacent to the target index; and
input the magnitude variance data, the phase variance data, the scatter plot data, and the spectrogram data.

14. The electronic device of claim 13, wherein the transceiver is configured to:
transmit and receive the radar signal every frame period during the time period.

15. The electronic device of claim 13, wherein the controller is configured to:
obtain the plurality of IQ components from a plurality of frames included in the time period, and obtain the scatter plot data based on accumulating the plurality of IQ components in one complex plane; and
perform a Short-Time Fourier Transform (STFT) on the plurality of range profiles with respect to the target index and the plurality of adjacent indices, and obtain the spectrogram data by accumulating the plurality of STFT range profiles.

16. The electronic device of claim 13, wherein the AI model comprises:
a first convolution neural network (CNN) model configured to obtain first prediction data with respect to a plurality of labels from the scatter plot data that are defined depending on the type of the target;
a second CNN model configured to obtain second prediction data with respect to the plurality of labels from the spectrogram data; and
a multi-layer perceptron (MLP) configured to output the output data from the magnitude variance data, the phase variance data, the first prediction data, and the second prediction data.

17. A method of operating an electronic device, the method comprising:
extracting a plurality of range profiles from a radar signal detected during a time period from a target;
obtaining magnitude variance data defined with respect to a plurality of magnitude components corresponding to a target index in the plurality of range profiles, phase variance data defined with respect to a plurality of phase components corresponding to the target index, scatter plot data defined with respect to a plurality of In-phase Quadrature (IQ) components corresponding to the target index, and spectrogram data defined with respect to the target index and a plurality of adjacent indices adjacent to the target index; and
obtaining output data with respect to a plurality of labels defined depending on a type of the target from an Artificial Intelligence (AI) model using the magnitude variance data, the phase variance data, the scatter plot data, and the spectrogram data as input data.

18. The method of claim 17, further comprising:
inputting training data into the AI model to train the AI model, the training data including examples of the magnitude variance data, the phase variance data, the scatter plot data, and the spectrogram data associated with one of the labels.

19. The method of claim 17, further comprising:
applying zero padding to the plurality of range profiles;
performing Fourier transform on the plurality of range profiles to which the zero padding is applied to generate a plurality of Fourier transformed range profiles; and
extracting an index of a peak point from the plurality of Fourier transformed range profiles as the target index.

20. The method of claim 17, further comprising:
transmitting and receiving the radar signal every frame period during the time period.
